(19) United States
(12) Patent Application Publication
(10) Pub. No.: US 2005/0127665 A1
(43) Pub. Date: Jun. 16, 2005

(54) High-pressure fuel pipe for diesel engines

(75) Inventors: Masayoshi Usui, Numazu-shi (JP); Kikuo Asada, Mishima-shi (JP); Teruhisa Takahashi, Mishima-shi (JP)

Correspondence Address: CASELLA & HESPOS, 274 MADISON AVENUE, NEW YORK, NY, 10016, US

(73) Assignee: Usui Kokusai Sangyo Kaisha Limited, Sunto-gun (JP)

(21) Appl. No.: 11/012,713

(22) Filed: Dec. 15, 2004

(30) Foreign Application Priority Data
Dec. 16, 2003 (JP) 2003-417719
Dec. 10, 2004 (JP) 2004-358758

(51) Int. Cl. F16L 45/00

(52) U.S. Cl. 285/197; 285/353

(57) ABSTRACT

There is provided a high-pressure fuel pipe for diesel engines, which is excellent in inner-pressure fatigue resistant property, vibrational fatigue resistant property, cavitation-resistant property, seat surface crack resistant property, and bending shape stability, and capable of thinning and lightening. A high-pressure fuel pipe for diesel engines, composed of a low alloy transformation inducing plastic type strength steel containing residual austenite of 5 to 40 wt %, and wherein an inner surface of a flow passage has a crack depth of 20 μm or less, and plastic working is applied to an inner surface of a flow passage.

### BACKGROUND OF THE INVENTION

1. Field of the Invention

The present invention relates to a high-pressure fuel pipe for internal combustion diesel engines (including a common rail, feed pipe for common rail, and fuel injection pipe).

2. Background Art

Known as a fuel injection pipe among high-pressure fuel pipes for diesel engines are ones, in which a frustum-shaped connection head 12 having a straight-shaped seat surface 13 defined on an outer peripheral surface of an end of a thick-walled steel pipe 11 shown in FIG. 1, or a connection head 22 having an arcuate-shaped seat surface 23 defined on an outer peripheral surface of an end of a thick-walled steel pipe 21 shown in FIG. 2 is formed by buckling working performed by push from outside by a punch member in an axial direction (see JP-A-2002-295336).

Generally, a steel pipe (STS370, 410 of JISG3455) having a tensile strength of the class of 340 N/mm² to 410 N/mm² has been used for such fuel injection pipe for diesel engines. As purification techniques have been developed to observe the regulation of exhaust gas for diesel engines, a method of purifying exhaust gases through atomized injection of a fuel at high pressure has been adopted, in which a fuel injection pipe is loaded by inner pressure equal to or higher than a conventional 1200 bar and demanded of a high inner-pressure fatigue strength, so that there is a tendency for the use of high tensile strength pipes having a tensile strength of the class of 490 N/mm² to 600 N/mm².

Such high tensile strength pipes cause, in some cases, minute wrinkle cracks (defect) having a depth of the order of 100 μm on an inner surface when manufactured from an ingot in hot pipe-making, and when worked to a necessary size from a large-diameter pipe in drawing (pipe elongation). It is known that such wrinkle cracks are caused by that difference in material flow between outside and inside, which is generated when a pipe is reduced in outside diameter by a die and rolled from inside by a plug in pipe elongation working. That is, such phenomenon occurs conspicuously in thick-walled pipes. Also, inner winkles caused by rolling with the plug remain as wrinkle cracks due to small ductility. In particular, when wrinkle cracks of the order of 100 μm are present on a pipe inner surface, fatigue failure occurs due to stress concentration generated on the wrinkle crack portion when high inner pressure of 1200 to 1600 bar is repeatedly applied in a pipe.

As a countermeasure, there is a conventional method of removing those wrinkle cracks on a pipe inner peripheral surface, which define a starting point to give rise to inner-pressure fatigue failure, with the use of a specific cutting technique. While the specific cutting technique can be used to remove a defect on the inner peripheral surface, which defines a starting point to give rise to inner-pressure fatigue failure, and to increase the inner-pressure fatigue strength, however, it is not possible to endure pressures of the order of 1800 bar or higher due to a limit in material strength. On the other hand, since vibrational fatigue strength is little increased, no effect is produced on that vibrational fatigue failure, in which an outer surface becomes a starting point to advance failure.

On the other hand, there is a method (autofrettage method) of applying pressure inside a pipe to generate a compression residual stress on an inner surface thereof. With this method, however, distribution of residual stress changes due to subsequent plastic deformation and disappears. Also, in case of generating a compression residual stress on an inner surface, the inner surface is susceptible of work hardening but a normal work hardening of a material makes inner-surface fatigue strength insufficient. While vibrational fatigue advances with an outer surface of a pipe as a main starting point, the outer surface is not absolutely increased in strength, so that the vibrational fatigue property is in no way improved.

Also, known as a common rail among high-pressure fuel pipes for diesel engines are the following arrangements. For example, as shown in FIG. 3, a boss 33 is formed on a main pipe rail 31 to be integral with the main pipe rail 31, a push seat surface 32-3 defined by a connection head 32-2 of a branch pipe 32 is caused to abut against and engage with a pressure receiving surface 31-3 on a side of the main pipe rail 31, and connection is achieved by clamping a cap nut 36, which is threaded onto a threaded portion 33-2 provided on an outer peripheral surface of the boss 33c. As shown in FIG. 4, a branch hole 31-2 provided on a peripheral wall on a side of a main pipe rail 31 and communicated to a flow passage 31-1 having a circular cross section defines an outwardly opened pressure receiving surface 31-3, a ring-shaped joint fittings 33 is used to surround an outer periphery of the main pipe rail 31 in the vicinity of the pressure receiving surface, a push seat surface 32-3 defined by a connection head 32-2 on a side of a branch pipe 32, as a branch connecting body, which is enlarged in diameter by buckling molding to assume, for example, a form of a tapered cone, is caused to abut against and engage with an end, and connection is achieved by push, below a neck of the connection head 32-2, caused by threading of a threaded wall 33-1, which is provided on the joint fittings to project radially of the main pipe rail 31 and projects outwardly of the main pipe rail 31, and a nut 34 beforehand assembled onto the branch pipe 32 through a sleeve washer 35. As shown in FIGS. 5 and 6, in place of the ring-shaped joint fittings 33, cylindrical-shaped sleeve nipples 33a, 33b, respectively, are attached directly to a outer peripheral wall of a main pipe rail 31 by a fitting threading method, welding, or the like in a manner to project radially outwardly of the main pipe rail 31, a push seat surface 32-3 defined by a connection head 32-2 on a side of a branch pipe 32 is caused to abut against and engage with a pressure receiving surface 31-3 on a side of the main pipe rail 31, a nut 34 being threaded onto the sleeve nipple 33a, 33b is clamped to achieve connection. A block rail type common rail (not shown) is also known as a common rail (see JP-A-2002-310034).

However, all the prior common rails described above involve the possibility that a large stress is generated on an inner peripheral edge P of a lower end of the branch hole 31-2 by internal pressure in the main pipe rail 31 and an axial force applied on the pressure receiving surface 31-3 by push of the connection head 32-2 of a branch connecting body such as the branch pipe 32, and crack is liable to generate with the inner peripheral edge P as a starting point to give rise to leakage of a fuel. Also, crack is liable to generate on an inner surface of the main pipe rail. This is because the main pipe rail comprises a thick-walled cylinder but a large tension stress in a circumferential direction is generated on the inner surface since an inner diameter is large.

### SUMMARY OF THE INVENTION

The invention has been thought of in order to solve the problem of the prior art described above and has its object to provide a high-pressure fuel pipe for diesel engines, which is excellent in inner-pressure fatigue resistant property, vibrational fatigue resistant property, cavitation-resistant property, and also excellent in seat surface crack resistant property, and bending shape stability, and capable of thinning and lightening.

A high-pressure fuel pipe for diesel engines, according to the invention, has a feature in that it is composed of a low alloy transformation inducing plastic type strength steel containing residual austenite of 5 to 40 wt %, and that an inner surface of a flow passage has a crack depth of 20 μm or less, and plastic working is applied to an inner surface of a flow passage.

In the invention, the reason why residual austenite of a low alloy transformation inducing plastic type strength steel is limited to 5 to 40 wt % is that in case of less than 5 wt %, a transformation quantity from residual austenite to martensite is small and a sufficient increase in strength cannot be achieved when exposed to a high stress while in excess of 40 wt %, it is hard to ensure a desired strength.

Also, the reason why an inner surface of a flow passage has a crack depth of 20 μm or less is that a nonmetallic inclusion in the steel generally has a magnitude larger than 20 μm.

Also, the reason why plastic working is applied to an inner surface of a flow passage is that by inducing martensite transformation, tensile strength is further enhanced to provide a high inner-pressure fatigue strength.

A high-pressure fuel pipe for diesel engines, according to the invention, is high in plastic deformability and is made of a low alloy transformation inducing plastic type strength steel, which makes a martensite structure by virtue of plastic working and is high in both strength and hardness, so that an entire pipe is high in strength and hardness, excellent in inner-pressure fatigue resistant property, vibrational fatigue resistant property, cavitation-resistant property, seat surface crack resistant property, and bending shape stability, and capable of thinning and lightening.

Also, a pipe has good workability in the course of working and has an inner surface, which is smooth (free of crack). Further, since reduction at the time of pipe elongation is made large, there is produced an effect that the number of times of pipe elongation can be reduced and working with the same reduction can be performed with a small pipe elongation machine and a small die.

### BRIEF DESCRIPTION OF THE DRAWINGS

FIG. 1 is a cross sectional view showing an essential part of an example of a high-pressure fuel pipe, to which the invention is directed;

FIG. 2 is a cross sectional view showing an essential part of a further example of a high-pressure fuel pipe, to which the invention is directed;

FIG. 3 is a vertical, cross sectional, front view showing an example of a boss integrated common rail, to which the invention is directed;

FIG. 4 is a vertical, cross sectional, side view of an essential part showing an example of a common rail using a ring-shaped joint fittings;

FIG. 5 is a vertical, cross sectional, side view showing an example of a common rail constructed such that a cylindrical-shaped sleeve nipple is mounted to a main pipe rail in a concave-convex fitting and threading manner; and

FIG. 6 is a vertical, cross sectional, side view showing an example of a common rail constructed such that a cylindrical-shaped sleeve nipple is mounted to a main pipe rail by welding.

### DESCRIPTION OF THE PREFERRED EMBODIMENTS

A low alloy transformation inducing plastic type strength steel in the invention has been developed in recent years with a view to lightening press molded parts related to an automobile's wheels, and comprises ferrite (α_{f})+bainite (α_{b})+γ_{R} composite structure steel [TRIP type Dual-Phase steel, TDP steel], and bainitic ferrite (α_{bf})+γ_{R} steel [TRIP type bainite steel, TB steel], which are remarkably improved in press moldability by utilization of strain inducing transformation (TRIP) of residual austenite (γ_{R}).

Here, transformation inducing plasticity means a large elongation caused when an austenite (γ) layer existent in a scientifically unstable state transforms into martens ite owing to addition of dynamic energy.

That is, TRIP steel means steel, in which metal structure with residual austenite and bainite structure mixed about the grain boundary of α layer is obtained by subjecting a certain limited plastic steel to a specified heat treatment. TRIP steel having such metal structure has a feature in that plastic deformability is high and it is high in strength and hardened since it becomes a martensite structure by virtue of working.

Since the high-pressure fuel pipe according to the invention is made of a low alloy transformation inducing plastic type strength steel containing residual austenite of 5 to 40 wt % having such properties, workability is good in the course of working and makes a pipe, of which an inner surface of a flow passage has a crack depth of 20 μm or less. Also, since reduction at the time of pipe elongation can be made large, the number of times of pipe elongation can be reduced and working with the same reduction can be performed with a small pipe elongation machine and a small die.

Also, since the austenite (γ) structure is enhanced in both hardness and tensile strength due to deposition of working inducing martensite, it is excellent in inner-pressure fatigue resistant property, cavitation-resistant property, seat surface crack resistant property, and bending shape stability.

Further, since the low alloy transformation inducing plastic type strength steel has such characteristics that austenite of a portion having been locally deformed transforms into hard martensite to strengthen such portion (TRIP phenomenon), a high-pressure fuel pipe made of such low alloy transformation inducing plastic type strength steel is long in service life as compared with conventional STS370, 410 of JISG3455 since the characteristics strengthens a portion, which has suffered fatigue, to produce resistance for inhibition of breakage even when vibrational fatigue and inner pressure fatigue advance.

As a method of manufacturing a high-pressure fuel pipe according to the invention, it is possible to use (A) using a mother pipe made of a low alloy transformation inducing plastic type strength steel containing residual austenite of 5 to 40 wt % to repeat pipe elongation/heat treatment, and carrying out the treatment for deposition of residual austenite to apply a final pipe elongation working to perform forming of a joint portion and bending without carrying out complete annealing in product size, (B) using the mother pipe made of the transformation inducing plastic type strength steel to repeat pipe elongation/heat treatment, carrying out the treatment for deposition of residual austenite after the pipe is finished to product size through the final pipe elongation working, and further carrying out forming of a joint portion and bending to subject an inner surface layer of the manufactured pipe body to plastic working, and (C) applying the inner surface crack removing processing (crack depth is made 20 μm or less) and the pipe elongation processing to a pipe containing a component of the transformation inducing plastic type strength steel to finish the same to a desired size, heating the steel pipe to 950° C. to compose the same of a single austenite layer, quenching the pipe to subject the same to the austempering treatment between 350° C. and 500° C., smoothing inner surfaces after cooling, and thereafter carrying out forming of a joint portion and bending.

In addition, a method of applying inner pressure to subject only an inner peripheral surface to plastic deformation (autofrettage working) is suitable as plastic working means in the invention. This is because in case of autofrettage working, residual stress caused by autofrettage working is effective for inner-pressure fatigue strength. That is, the steel type is higher in work hardening than that not containing residual austenite. Accordingly, an increase in inner-pressure fatigue strength is large due to an increase in hardness caused by autofrettage working.

### EMBODIMENTS

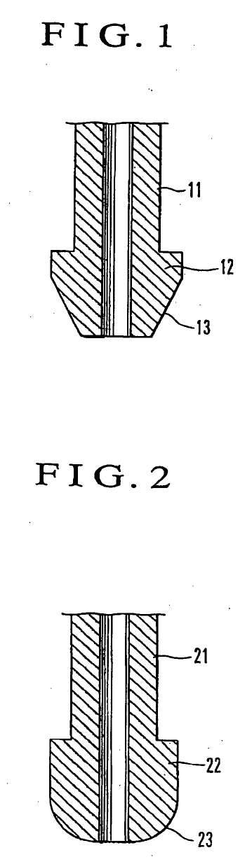

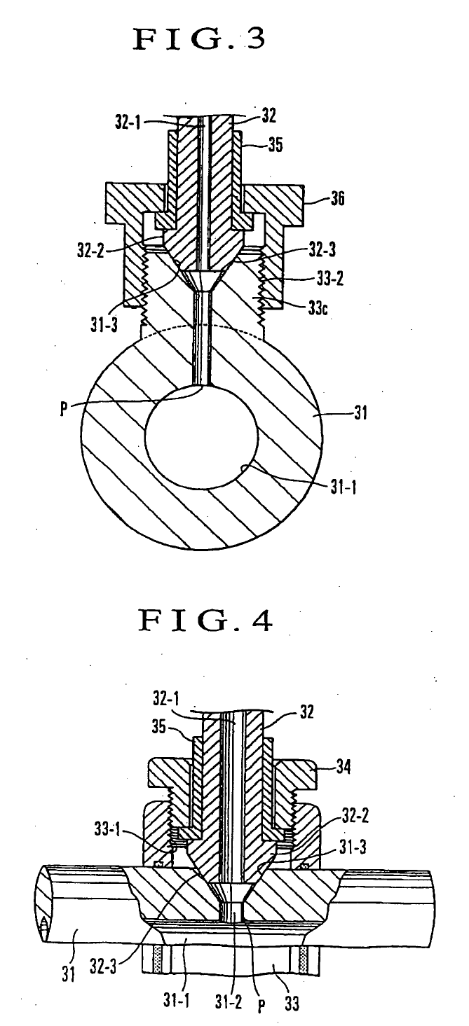

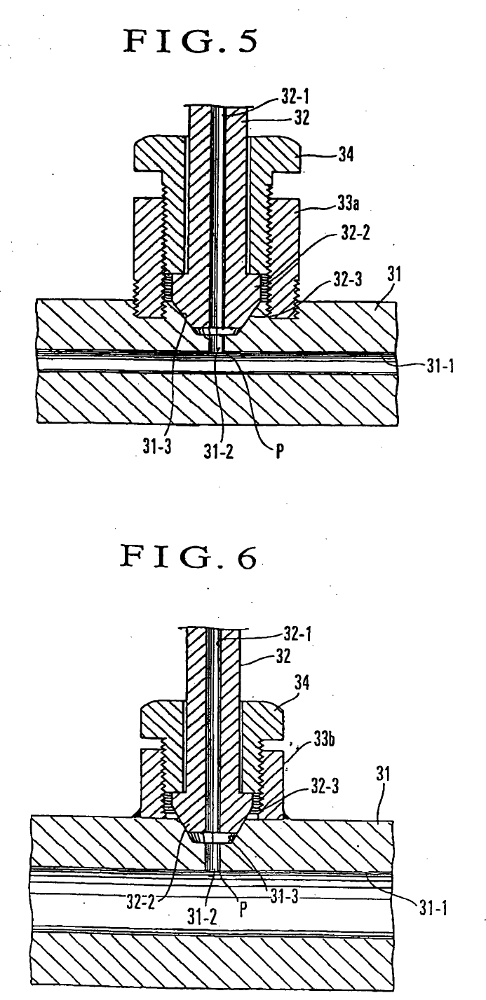

Embodiments of the invention will be described below. In addition, Embodiments 1 to 6 and Comparative examples 1 to 6 correspond to the case of the high-pressure fuel pipes shown in FIGS. 1 and 2, Embodiments 7, 8 correspond to boss integrated common rails shown in FIG. 3, and Embodiment 9 corresponds to common rails made of steel, shown in FIGS. 4 to 6.

### Embodiment 1

A seamless steel pipe (mother pipe) made of A steel containing components shown in TABLE 1 and sized to have an outside diameter of 34 mm, a wall thickness of 4.5 mm, and an inside diameter of 25 mm was used to be repeatedly subjected to predetermined pipe elongation and annealing, austenitized at 950° C. for 12 minutes, thereafter subjected to austempering treatment to be held at 450° C. for 5 minutes (volume fraction of residual austenite being 5.0%), and thereafter subjected to final pipe elongation working to provide a TB steel pipe, product size of which includes an outside diameter of 8 mm, a wall thickness of 2 mm, and an inside diameter of 4 mm, and forming of a joint portion thereof and bending were carried out to provide a product without annealing in product size.

### Embodiment 2

A seamless steel pipe (mother pipe) made of A steel containing components shown in TABLE 1 and sized to have an outside diameter of 34 mm, a wall thickness of 4.5 mm, and an inside diameter of 25 mm was used to be repeatedly subjected to predetermined pipe elongation and annealing, and thereafter subjected to final pipe elongation working to provide a TB steel pipe having a product size including an outside diameter of 8 mm, a wall thickness of 2 mm, and an inside diameter of 4 mm, the TB steel pipe thus obtained was austenitized at 950° C. for 12 minutes, and thereafter subjected to austempering treatment to be held at 425° C. for 5 minutes (volume fraction of residual austenite being 11.2%), and thereafter forming of a joint portion thereof, bending, and autofrettage working (inner pressure, at which a portion from an inner surface to a region corresponding to a wall thickness of 50% yielded) were carried out in product size.

### Embodiment 3

A seamless steel pipe (mother pipe) made of A steel containing components shown in TABLE 1 and sized to have an outside diameter of 34 mm, a wall thickness of 4.5 mm, and an inside diameter of 25 mm was used to be repeatedly subjected to predetermined pipe elongation and annealing, and thereafter subjected to final pipe elongation working to provide a TB steel pipe, product size of which includes an outside diameter of 8 mm, a wall thickness of 2 mm, and an inside diameter of 4 mm, the TB steel pipe thus obtained was austenitized at 780° C. for 12 minutes, thereafter subjected to austempering treatment to be held at 400° C. for 10 minutes (volume fraction of residual austenite being 13.7%), and subjected to rustproofing after cooling, and thereafter forming of a joint portion thereof and bending were carried out in product size to provide a product.

### Embodiment 4

A seamless steel pipe (mother pipe) made of B steel containing components shown in TABLE 1 and sized to have an outside diameter of 34 mm, a wall thickness of 4.5 mm, and an inside diameter of 25 mm was used to be subjected at an inner surface thereof to crack removal working by cutting to have a crack depth of 20 μm or less on the inner surface of a flow passage, repeatedly subjected to predetermined pipe elongation and annealing, and thereafter subjected to final pipe elongation working to provide a TB steel pipe, product size of which includes an outside diameter of 8 mm, a wall thickness of 2 mm, and an inside diameter of 4 mm, the TB steel pipe thus obtained was austenitized at 950° C. for 12 minutes, thereafter subjected to austempering treatment to be held at 450° C. for 5 minutes (volume fraction of residual austenite being 22.0%), and subjected to inner surface purifying treatment and rustproofing after cooling, and thereafter forming of a joint portion thereof, bending, and autofrettage working (inner pressure, at which a portion from an inner surface to a region corresponding to a wall thickness of 50% yielded) were carried out in product size to provide a product.

### Embodiment 5

A seamless steel pipe (mother pipe) made of B steel containing components shown in TABLE 1 and sized to have an outside diameter of 34 mm, a wall thickness of 4.5 mm, and an inside diameter of 25 mm was used to be subjected at an inner surface thereof to crack removal working by cutting to have a crack depth of 20 μm or less on the inner surface of a flow passage, repeatedly subjected to predetermined pipe elongation and annealing, and thereafter subjected to final pipe elongation working to provide a TB steel pipe, product size of which includes an outside diameter of 8 mm, a wall thickness of 2 mm, and an inside diameter of 4 mm, the TB steel pipe thus obtained was austenitized at 950° C. for 12 minutes, thereafter subjected to austempering treatment to be held at 425° C. for 5 minutes (volume fraction of residual austenite being 34.4%), and subjected to inner surface purifying treatment and rustproofing after cooling, and thereafter forming of a joint portion thereof, bending, and autofrettage working (inner pressure, at which a portion from an inner surface to a region corresponding to a wall thickness of 50% yielded) were carried out in product size to provide a product.

### Embodiment 6

A seamless steel pipe (mother pipe) made of B steel containing components shown in TABLE 1 and sized to have an outside diameter of 34 mm, a wall thickness of 4.5 mm, and an inside diameter of 25 mm was used to be subjected at an inner surface thereof to crack removal working by cutting to have a crack depth of 20 μm or less on the inner surface of a flow passage, repeatedly subjected to predetermined pipe elongation and annealing, and thereafter subjected to final pipe elongation working to provide a TB steel pipe, product size of which includes an outside diameter of 8 mm, a wall thickness of 2 mm, and an inside diameter of 4 mm, the TB steel pipe thus obtained was austenitized at 780° C. for 12 minutes, thereafter subjected to austempering treatment to be held at 400° C. for 10 minutes (volume fraction of residual austenite being 39.2%), and subjected to inner surface purifying treatment and rustproofing after cooling, and thereafter forming of a joint portion thereof, bending, and autofrettage working (inner pressure, at which a portion from an inner surface to a region corresponding to a wall thickness of 50% yielded) were carried out in product size to provide a product.

### COMPARATIVE EXAMPLE 1

A seamless steel pipe (mother pipe) made of A steel containing components shown in TABLE 1 and sized to have an outside diameter of 34 mm, a wall thickness of 4.5 mm, and an inside diameter of 25 mm was used to be repeatedly subjected to predetermined pipe elongation and annealing, thereafter austenitized at 950° C. for 12 minutes, thereafter subjected to austempering treatment to be held at 400° C. for 5 minutes (volume fraction of residual austenite being 4.2%), and thereafter subjected to final pipe elongation working to provide a TB steel pipe, product size of which includes an outside diameter of 8 mm, a wall thickness of 2 mm, and an inside diameter of 4 mm, and forming of a joint portion thereof and bending were carried out to provide a product without annealing in product size.

### COMPARATIVE EXAMPLE 2

A seamless steel pipe (mother pipe) made of A steel containing components shown in TABLE 1 and sized to have an outside diameter of 34 mm, a wall thickness of 4.5 mm, and an inside diameter of 25 mm was used to be repeatedly subjected to predetermined pipe elongation and annealing, and thereafter subjected to final pipe elongation working to provide a TB steel pipe, product size of which includes an outside diameter of 8 mm, a wall thickness of 2 mm, and an inside diameter of 4 mm, the TB steel pipe thus obtained was austenitized at 950° C. for 12 minutes, and thereafter subjected to austempering treatment to be held at 475° C. for 5 minutes (volume fraction of residual austenite being 1.7%), and thereafter forming of a joint portion thereof, bending, and autofrettage working (inner pressure, at which a portion from an inner surface to a region corresponding to a wall thickness of 50% yielded) were carried out in product size.

### COMPARATIVE EXAMPLE 3

A seamless steel pipe (mother pipe) made of A steel containing components shown in TABLE 1 and sized to have an outside diameter of 34 mm, a wall thickness of 4.5 mm, and an inside diameter of 25 mm was used to be repeatedly subjected to predetermined pipe elongation and annealing, and thereafter subjected to final pipe elongation working to provide a TB steel pipe, product size of which includes an outside diameter of 8 mm, a wall thickness of 2 mm, and an inside diameter of 4 mm, the TB steel pipe thus obtained was austenitized at 950° C. for 12 minutes, and thereafter subjected to austempering treatment to be held at 500° C. for 5 minutes (volume fraction of residual austenite being 0%), and thereafter forming of a joint portion thereof, bending, and autofrettage working (inner pressure, at which a portion from an inner surface to a region corresponding to a wall thickness of 50% yielded) were carried out in product size.

### COMPARATIVE EXAMPLE 4

A seamless steel pipe (mother pipe) made of B steel containing components shown in TABLE 1 and sized to have an outside diameter of 34 mm, a wall thickness of 4.5 mm, and an inside diameter of 25 mm was used to be subjected at an inner surface of a flow passage to crack removal working by cutting to have a crack depth of 20 μm or less on the inner surface of the flow passage, repeatedly subjected to predetermined pipe elongation and annealing, and thereafter subjected to final pipe elongation working to provide a TB steel pipe, product size of which includes an outside diameter of 8 mm, a wall thickness of 2 mm, and an inside diameter of 4 mm, the TB steel pipe thus obtained was austenitized at 950° C. for 12 minutes, thereafter subjected to austempering treatment to be held at 400° C. for 5 minutes (volume fraction of residual austenite being 4.5%), and subjected at an outer surface thereof to rustproofing after cooling, and thereafter forming of a joint portion thereof and bending were carried out in product size to provide a product.

### COMPARATIVE EXAMPLE 5

A seamless steel pipe (mother pipe) made of B steel containing components shown in TABLE 1 and sized to have an outside diameter of 34 mm, a wall thickness of 4.5 mm, and an inside diameter of 25 mm was used to be subjected at an inner surface of a flow passage to crack removal working by cutting to have a crack depth of 20 μm or less on the inner surface of the flow passage, repeatedly subjected to predetermined pipe elongation and annealing, and thereafter subjected to final pipe elongation working to provide a TB steel pipe, product size of which includes an outside diameter of 8 mm, a wall thickness of 2 mm, and an inside diameter of 4 mm, the TB steel pipe thus obtained was austenitized at 950° C. for 12 minutes, thereafter subjected to austempering treatment to be held at 475° C. for 5 minutes (volume fraction of residual austenite being 2.3%), and subjected at an outer surface thereof to rustproofing after cooling, and thereafter forming of a joint portion thereof and bending were carried out in product size to provide a product.

### COMPARATIVE EXAMPLE 6

A seamless steel pipe (mother pipe) made of B steel containing components shown in TABLE 1 and sized to have an outside diameter of 34 mm, a wall thickness of 4.5 mm, and an inside diameter of 25 mm was used to be subjected at an inner surface of a flow passage to crack removal working by cutting to have a crack depth of 20 μm or less on the inner surface of the flow passage, repeatedly subjected to predetermined pipe elongation and annealing, and thereafter subjected to final pipe elongation working to provide a TB steel pipe, product size of which includes an outside diameter of 8 mm, a wall thickness of 2 mm, and an inside diameter of 4 mm, the TB steel pipe thus obtained was austenitized at 950° C. for 12 minutes, thereafter subjected to austempering treatment to be held at 500° C. for 5 minutes (volume fraction of residual austenite being 0%), and subjected at an outer surface thereof to rustproofing after cooling, and thereafter forming of a joint portion thereof and bending were carried out in product size to provide a product.

TABLE 2 indicates results of the endurance test conducted on the products obtained in Embodiments 1 to 6 and Comparative examples 1 to 6. In addition, the results of the endurance test in TABLE 2 are those of repeat tests in 5 million cycles with the use of hydraulic pressure, which ranged from a base pressure 18 to a peak pressure.

As apparent from the results in TABLE 2, it has been found that while all the products (Embodiments 1 to 6) of the invention made of TRIP steel and having a volume fraction of residual austenite of 5% or more are excellent in inner-pressure fatigue resistant property owing to martensite transformation induced by the final pipe elongation working, the products of Comparative examples 1 to 6 made of the same TRIP steel as above and having a volume fraction of residual austenite of less than 5% are inferior in inner-pressure fatigue resistant property.

In addition, finished elongated pipe products manufactured by the use of a seamless steel pipe made of an ordinary high strength steel (SCM435) (C of 0.33 to 0.38 mass %, Si of 0.15 to 0.35 mass %, Mn of 0.60 to 0.85 mass %, P of 0.030 mass % or less, S of 0.030 mass % or less, Cr of 0.90 to 1.20 mass %, Mo of 0.15 to 0.30 mass %) caused work hardening to make head formation and bending impossible, and bending of products having been subjected to ordinary heat treatment (quenching, tempering) were impossible.

### Embodiment 7

A round bar for forging, made of A steel containing components shown in TABLE 1 was cut to a predetermined dimension, heated to a hot forging temperature, forged into a boss integrated common rail (of which a cylindrical portion had an outside diameter of 34 mmφ) by die forging, thereafter subjected to working as by cutting to provide for an inside diameter of 10 mmφ, a boss branch hole diameter of 3 mmφ, a seat surface, a threaded portion, etc., austenitized at 950° C. for 20 minutes, and thereafter subjected to austempering treatment to be held at 400° C. for 3 minutes (volume fraction of residual austenite being 5.0%) to provide a boss integrated common rail having a structure with a residual austenite (γ) layer and a bainite structure mixed about the grain boundary of a layer, and a pressing force in the form of external pressure was applied to branch holes of respective bosses of the common rail to generate a compression residual stress about ends of openings of the branch holes in a flow passage in a main pipe rail. In addition, since at the time of cutting the residual austenite layer and the bainite structure were present in small amounts, tensile strength was small and elongation was also small, so that working was very easy.

As a result of examining the common rail in a repeated pressure tester with respect to fatigue limit, a common rail used as a comparative material, having the same size and made of an ordinary high strength steel (SCM435) (C of 0.33 to 0.38 mass %, Si of 0.15 to 0.35 mass %, Mn of 0.60 to 0.85 mass %, P of 0.030 mass % or less, S of 0.030 mass % or less, Cr of 0.90 to 1.20 mass %, Mo of 0.15 to 0.30 mass %) broke down at 800,000 cycles in repetitive test at hydraulic pressure of 180 to 1500 Bar while the common rail of the invention did not break down at 10,000,000 cycles in repetitive test at hydraulic pressure of 2200 Bar and exhibited an excellent inner-pressure fatigue resistant property.

### Embodiment 8

A round bar for forging, made of. A steel containing components shown in TABLE 1 was cut to a predetermined dimension, austenitized at 950° C. for 20 minutes, and thereafter subjected to austempering treatment to be held in the range of 350 to 475° C. for 3 minutes (volume fraction of residual austenite being 11.2%) to form a structure with a residual austenite (γ) layer and a bainite structure mixed about the grain boundary of a layer, the semi-processed product was forged into a boss integrated common rail (of which a cylindrical portion had an outside diameter of 34 mmφ) by die forging, and thereafter subjected at an inside diameter of 10.6 mmφ, a boss branch hole diameter of 3 mmφ, a seat surface, a threaded portion, etc. to working as by cutting to provide a boss integrated common rail, and thereafter a pressing force in the form of external pressure was applied to branch holes of respective bosses of the common rail to generate a compression residual stress about ends of openings of the branch holes in a flow passage in a main pipe rail. In addition, while the residual austenite layer and the bainite structure were present at the time of forging, forging working was possible since elongation was large although tensile strength was large. Further, autofrettage working was carried out by application of inner pressure, which could cause a portion from an inner surface of the cylindrical portion to a region corresponding to a wall thickness of 50% to yield.

As a result of examining the common rail in a repeated pressure tester with respect to fatigue limit, the common rail did not break down at 10,000,000 cycles in repetitive test at hydraulic pressure of 2400 Bar and exhibited a more excellent inner-pressure fatigue resistant property.

### Embodiment 9

A common rail material (a pipe having an outside diameter of 36 mmφ and an inside diameter of 10 mmφ) obtained by cutting a seamless steel pipe made of A steel containing components shown in TABLE 1, to a predetermined dimension was subjected to a desired working as by cutting to provide for a boss branch hole diameter of 3 mmφ, a seat surface, a threaded portion, etc., austenitized at 950° C. for 20 minutes, and thereafter subjected to austempering treatment to be held in the range of 350 to 475° C. for 3 minutes (volume fraction of residual austenite being 13.7%) to provide a common rail having a structure with a residual austenite (γ) layer and a bainite structure mixed about the grain boundary of a layer, and a pressing force in the form of external pressure was applied to a branch hole of the common rail to generate a compression residual stress about an end of an opening of the branch hole in a flow passage in a main pipe rail. In addition, since at the time of cutting the residual austenite layer and the bainite structure were present in small amounts, tensile strength was small and elongation was also small, so that working was very easy.

As a result of examining the common rail in a repeated pressure tester with respect to fatigue limit, the common rail according to the embodiment did not break down at 10,000,000 cycles in repetitive test at hydraulic pressure of 2200 Bar and exhibited an excellent inner-pressure fatigue resistant property.

TABLE 1

| | C | Si | Mn | P | S | Al |
|---|---|---|---|---|---|---|
| A steel | 0.17 | 1.40 | 1.80 | 0.010 | 0.003 | 0.03 |
| B steel | 0.40 | 1.51 | 1.50 | 0.015 | 0.003 | 0.023 |

(mass %)

TABLE 2

| | | | Presence and | Volume fraction of | | | | |
|---|---|---|---|---|---|---|---|---|
| | | | absence of crack | residual austenite | | | | Crack depth |
| Test No. | | Steel type | removal | (%) | Results of endurance test | | | (μm) |
| Invention | 1 | A steel | No crack removal | 5.0 | 18-250 MPa | n = 3 | No breakage | 20 μm or less |
| | 2 | A steel | No crack removal | 11.2 | 18-250 MPa | n = 3 | No breakage | ” |
| | 3 | A steel | No crack removal | 13.7 | 18-250 MPa | n = 3 | No breakage | ” |
| | 4 | B steel | Crack removal | 22.0 | 18-250 MPa | n = 3 | No breakage | ” |
| | 5 | B steel | Crack removal | 34.4 | 18-250 MPa | n = 3 | No breakage | ” |
| | 6 | B steel | Crack removal | 39.2 | 18-250 MPa | n = 3 | No breakage | ” |
| Comparative | 1 | A steel | No crack removal | 4.2 | 18-240 MPa | n = 1 | Burst | 25 |
| Example | 2 | A steel | No crack removal | 1.7 | 18-250 MPa | n = 1 | Burst | 40 |
| | 3 | A steel | No crack removal | 0 | 18-220 MPa | n = 1 | Burst | 32 |
| | 4 | B steel | Crack removal | 4.5 | 18-250 MPa | n = 1 | Burst | 7 |
| | 5 | B steel | Crack removal | 2.3 | 18-250 MPa | n = 1 | Burst | 12 |
| | 6 | B steel | Crack removal | 0 | 18-250 MPa | n = 1 | Burst | 10 |

1. A high-pressure fuel pipe for diesel engines, composed of a low alloy transformation inducing plastic type strength steel containing residual austenite of 5 to 40 wt %.

2. The high-pressure fuel pipe for diesel engines, according to claim 1, wherein an inner surface of a flow passage has a crack depth of 20 μm or less.

3. The high-pressure fuel pipe for diesel engines, according to claim 2, wherein plastaic working is applied to an inner surface of a flow passage.

4. The high-pressure fuel pipe for diesel engines, according to claim 3, wherein the plastic working comprises autofrettage working.

5. The high-pressure fuel pipe for diesel engines, according to claim 1, wherein the low alloy transformation inducing plastic type strength steel comprises ferrite (α_{f})+bainite (α_{b})+γ_{R} composite structure steel [TRIP type Dual-Phase steel, TDP steel], and bainitic ferrite (α_{bf})+γ_{R} steel [TRIP tpe bainite steel, TB steel], which are improved in press molding quality by utilization of strain inducing transformation (TRIP) of residual austenite (γ_{R}).
